(19) United States
(12) Patent Application Publication
(10) Pub. No.: US 2014/0264088 A1
(43) Pub. Date: Sep. 18, 2014

(54) INFRARED SELECTIVE FILTER OR LENS

(71) Applicant: GM GLOBAL TECHNOLOGY OPERATIONS LLC, Detroit, MI (US)

(72) Inventor: Michael K. Larsen, Troy, MI (US)

(21) Appl. No.: 13/945,331

(22) Filed: Jul. 18, 2013

Related U.S. Application Data
(63) Continuation-in-part of application No. 13/840,360, filed on Mar. 15, 2013, now abandoned.

(51) Int. Cl. G02B 5/20; F21V 9/00

(52) U.S. Cl. CPC G02B 5/208; F21V 9/00
USPC 250/504 R; 359/350

(57) ABSTRACT

A number of variations may include an infrared selective filter or lens for use with a vehicle headlamp or light transmitting device. A number of variations may include a vehicle headlamp including an infrared selective filter or lens. A number of variations may include a vehicle including a light transmitting device including moveable infrared selective filter or lens.

### CROSS-REFERENCE TO RELATED APPLICATIONS

This application is continuation-in-part of U.S. patent application Ser. No. 13/840,360 filed on Mar. 15, 2013.

### TECHNICAL FIELD

The field to which the disclosure generally relates to includes infrared selective filters or lens, headlamps including the same, and methods of using the same.

### BACKGROUND

Vehicles may be equipped with headlamps.

### SUMMARY OF ILLUSTRATIVE VARIATIONS

A number of variations may include an infrared selective filter or lens for use with a vehicle headlamp.

A number of variations may include a vehicle headlamp including an infrared selective filter or lens.

Other illustrative variations within the scope of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a perspective view of a vehicle headlamp assembly according to a number of variations of the invention.

FIG. 2A is a partial view of a headlamp assembly showing an infrared selective filter or lens in a closed position according to a number of variations of the invention.

FIG. 2B is an illustration of the view from inside a headlamp assembly shown in FIG. 2A from the position of the headlamp bulb looking toward a condensing lens and showing an infrared selective filter or lens in a closed position according to a number of variations of the invention.

FIG. 2C is a graphic illustration of the energy blocked by the infrared transmitting bifunctional projector shield in the closed position as shown in FIGS. 2A-B.

FIG. 3A is a partial view of a headlamp assembly showing an infrared selective filter or lens in an open position according to a number of variations of the invention.

FIG. 3B is an illustration of a view from inside the headlamp assembly of FIG. 3A from the position of the headlamp looking toward a condensing lens and showing an infrared selective filter or lens in an open position according to a number of variations of the invention.

FIG. 3C is a graphic illustration of the energy transmitted when the infrared selective filter or lens is in an open position and the lamp assembly is operated to project a high beam pattern according to a number of variations of the invention.

FIG. 4 is a graphical illustration of a headlamp bulb output spectrum and identifying the wavelength for the infrared portion of the spectrum.

FIG. 5 is an infrared selective filter or lens transmittance chart.

FIG. 6 is a schematic illustration of a vehicle system including a headlamp assembly having an infrared selective filter or lens according to a number of variations of the invention.

FIG. 7 illustrates an infrared selective filter or lens pivotally connected to a lamp housing and to a solenoid to move the shield from an open position when the headlamp assembly projects a high beam pattern to a closed position wherein infrared waves are transmitted from the shield according to a number of variations of the invention.

FIG. 8 is an illustration of a vehicle having a headlamp assembly including having an infrared selective filter or lens according to a number of variations of the invention.

### DETAILED DESCRIPTION OF ILLUSTRATIVE VARIATIONS

The following description of the variations is merely illustrative in nature and is in no way intended to limit the scope of the invention, its application, or uses.

In a number of variations the infrared selective filter or lens may be constructed and arranged to function as a bifunctional projection shield for a headlamp. A number of variations of the invention are illustrated in FIG. 1 and may include a product 10 including an infrared selective filter or lens 12 useful in a headlamp assembly 14. The headlamp assembly 14 may include a lamp housing 16 having a light reflective surface 18 inside of the housing and a headlamp bulb 20 positioned in the housing to project light onto the reflective surface 18 and out of a light projection opening 19 in the housing 16 toward a condensing lens 22. The reflective surface 18 may be of a generally elliptical configuration. The condensing lens 22 may be held by a bracket 24 from which a plurality of legs 26 may extend there from and connected to the lamp housing 16. In a number of variations of the invention the infrared selective filter or lens 12 may be provided to be movable to a closed position wherein at least a portion of the light emitted from the lamp 20 is blocked by the infrared selective filter or lens 12 but so that infrared light waves are transmitted through the condensing lens 22 into the path in front of a vehicle in which the headlamp assembly 14 is included.

In a number of variations the infrared selective filter or lens may be constructed and arranged to function as a bifunctional projection shield for a headlamp. A number of variations of the invention are illustrated in FIG. 1 and may include a product 10 including an infrared selective filter or lens 12 useful in a headlamp assembly 14. The headlamp assembly 14 may include a lamp housing 16 having a light reflective surface 18 inside of the housing and a headlamp bulb 20 positioned in the housing to project light onto the reflective surface 18 and out of a light projection opening 19 in the housing 16 toward a condensing lens 22. The reflective surface 18 may be of a generally elliptical configuration. The condensing lens 22 may be held by a bracket 24 from which a plurality of legs 26 may extend there from and connected to the lamp housing 16. In a number of variations of the invention the infrared selective filter or lens 12 may be provided to be movable to a closed position wherein at least a portion of the light emitted from the lamp 20 is blocked by the infrared selective filter or lens 12 but so that infrared light waves are transmitted through the condensing lens 22 into the path in front of a vehicle in which the headlamp assembly 14 is included.

In a number of variations the infrared selective filter or lens 12 may be constructed and arranged to block at least 5 percent, at least 25 percent, at least 35 percent, at least 40 percent, at least 50 percent, at least 55 percent, at least 60 percent, at least 65 percent, at least 70 percent or at least 100 percent of the visible light from the projection opening 19 in the housing 16. In a number of variations the infrared selective filter or lens 12 may be constructed and arranged to block 5-100 percent of the light projection opening 19 in the housing 16.

In a number of variations of the invention the infrared selective filter or lens 12 may include a substrate including material for allowing the transmission of infrared wave or energy there through or having an infrared transmissible coating thereon. Non-limiting examples of infrared materials for allowing the transmission of infrared wave or energy there through include but are not limited to, arsenic trisulfide, barium fluoride, cadmium fluoride, fused silica, gallium arsenide, IR polymers, lead fluoride, lithium fluoride, magnesium fluoride, sapphire (AL₂O₃), sodium chloride, silicon, thallium bromo-iodide, zinc selenide, and/or zinc sulfide.

In a number of variations the shield may include a material constructed and arranged to block visible light (380 nm-700 nm) but allow infrared waves (700 nm-1 nm) or waves greater than 700 nm to pass therethrough.

In a number of variations of the invention the infrared selective filter or lens 12 may have optical properties to better direct infrared waves into area in front of the vehicle that are important for collecting data from an infra sensor or infrared camera. In a number of variations of the invention the infrared selective filter or lens 12 may direct infrared waves slightly upward so that the a upper portion (“cutoff” portion) nearest the center of the opening 19 in housing 16 to be made of metal or another opaque material.

In a number of variations the infrared selective filter or lens 12 may be pivotally connected to the lamp housing 16. An actuator 28 may be operatively connected to the infrared selective filter or lens 12 to move the infrared selective filter or lens 12 from a closed position shown in FIG. 2A to an open position shown in FIG. 3A and vice versa. In one variation of the invention the actuator 28 may be a solenoid. In a number of other variations the actuator 28 may be a hydraulic, pneumatic or electric piston, or a stepper motor. In other variations of the invention the infrared selective filter or lens 12 may be arranged to be moved up and down or in a sideways direction in the same plane to move in and out of a position blocking a portion of the light transmitted by the lamp bulb 20 and reflective surface 18.

In other variations of the invention, the infrared selective filter or lens 12 may be constructed and arranged to selectively block portions of the visible light spectrum other than the infrared portion or wavelength of the light. For example, an arrangement of nano-devices may be positioned to allow the full spectrum of visible light to be transmitted through the nano-devices so that the headlamp projects a high beam pattern and may be movable to another position so that only infrared wavelengths are transmitted through the shield when desired.

FIG. 2A is a partial view of a headlamp assembly 14 showing an infrared selective filter or lens 12 in a closed position according to a number of variations of the invention. FIG. 2B is an illustration of the view from inside a headlamp assembly 14 shown in FIG. 2A from the position of the headlamp bulb 20 looking toward a condensing lens 22 and showing infrared selective filter or lens 12 in a closed position according to a number of variations of the invention. FIG. 2C is a graphic illustration of the energy blocked by infrared selective filter or lens 12 in the closed position as shown in FIGS. 2A-B.

FIG. 3A is a partial view of a headlamp assembly 14 showing an infrared selective filter or lens 12 in an open position according to a number of variations of the invention. FIG. 3B is an illustration of a view from inside the headlamp assembly 14 of FIG. 3A from the position of the headlamp bulb 20 looking toward a condensing lens 22 and showing an infrared selective filter or lens 12 in an open position according to a number of variations of the invention. FIG. 3C is a graphic illustration of the energy transmitted when the infrared selective filter or lens 12 is in an open position and the headlamp assembly 14 is operated to project a high beam pattern according to a number of variations of the invention.

FIG. 4 is a graphical illustration of a headlamp bulb output spectrum and identifying the wavelength for the infrared portion of the spectrum.

FIG. 5 is an infrared selective filter or lens transmittance chart.

FIG. 6 is a schematic illustration of a vehicle system including a night vision system 30 which may include the headline assembly 14 constructed and arranged to project visible light waves 32 and infrared waves 34 for example in the path in front of a vehicle. The infrared waves 34 create an infrared field of vision 36 from which infrared waves 34 are projected from objects in the infrared field of view 36 back toward the vehicle which may be detected and/or captured by an infrared sensor 38 and/or an infrared camera 40. Data from at least one of the infrared sensor 38 and/or infrared camera 40 may be communicated to a display 42 positioned in the vehicle to be seen by the vehicle operator. A controller 44 may be provided to control the operation of the headlamp assembly 14 to selectively cause the infrared selective filter or lens 12 to move to a closed position so that infrared waves 34 pass through the infrared selective filter or lens 12 but visible light waves are block by the filter or lens 12 when desired.

FIG. 7 illustrates an infrared selective filter or lens 12 pivotally connected to a lamp housing 16 and to an actuator 28 such as, but not limited to, a solenoid to move the shield 12 from an open position when the headlamp assembly projects a high beam pattern to a closed position wherein infrared waves are transmitted from the shield according to a number of variations of the invention. Again, in a number of other variations the actuator 28 may be a hydraulic, pneumatic or electric piston, or a stepper motor.

FIG. 8 is an illustration of a vehicle 46 having a headlamp assembly 14 including having an infrared selective filter or lens 12 according to a number of variations of the invention. In a number of variation the vehicle 46 having a headlamp assembly 14 including having an infrared selective filter or lens 12 does not include another infrared transmitting source positioned to transmit infrared wave in the forward direction of movement of the vehicle. This result in a significant cost saving.

Yet in a number of other variations, the additional infrared transmitter devices or sources are provided. The additional infrared transmitter devices or sources may be made to operate on less power than traditional infrared transmitters in vehicle because the headlamp including an infrared selective filter or lens supplements the infrared wave projected by the additional infrared transmitters.

A number of variations of the invention are not limited to a projection type headlamp. A number of variations of the invention may include any type of light transmitting device including devices traditional utilized as only IR transmitter on vehicle. A number of variations of the invention include device such as tradition IR transmitters for vehicle but which include a lens or shield constructed and arranged to allow the transmission of infrared waves or energy there through and wherein the lens or shield is moveably by an actuator from a first position allow a certain (first) amount of visible light to pass over or around the lens or shield and to a second position wherein a second amount or visible light is allowed to pass over or around the lens or shield, which is more than or less than the certain (first) amount.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising an infrared selective filter or lens constructed and arranged to be received in a vehicle headlamp assembly.

Variation 2 may include product as set forth in Variation 1 wherein the infrared selective filter or lens comprises a substrate having an infrared transmitting coating thereon.

Variation 3 may include product as set forth in any of Variations 1-2 wherein infrared selective filter or lens comprises a substrate comprising at least one of arsenic trisulfide, barium fluoride, cadmium fluoride, fused silica, gallium arsenide, IR polymers, lead fluoride, lithium fluoride, magnesium fluoride, sapphire (AL₂O₃), sodium chloride, silicon, thallium bromo-iodide, zinc selenide, or zinc sulfide so that the infrared selective filter or lens is constructed and arranged to allow infrared waves to pass there through.

Variation 4 may include product as set forth in any of Variations 1-3 wherein the infrared selective filter or lens is constructed and arranged to block at least 5 percent of an opening in a housing of the headlamp assembly.

Variation 5 may include product as set forth in any of Variations 1-4 further comprising a headlamp assembly housing having a light projection opening formed therein, a reflective surface formed on an inner surface of the housing communicating with the light projection opening, a headlamp bulb received in the headlamp housing and positioned to direct light onto the reflective surface, wherein the infrared selective filter or lens is operatively connected to an actuator to move the infrared selective filter or lens from an open position to a closed position.

Variation 6 may include product as set forth in Variation 5 wherein the infrared selective filter or lens is pivotally connected to the housing.

Variation 7 may include product as set forth in any of Variations 5-6 wherein the actuator comprises a solenoid, a hydraulic, pneumatic or electric piston, or a stepper motor.

Variation 8 may include product as set forth in any of Variations 5-7 further comprising a vehicle and wherein the headlamp assembly including the infrared selective filter or lens is positioned in the vehicle so that infrared waves from the infrared selective filter or lens produces an infrared field of vision in front of the forward path of the vehicle.

Variation 9 may include product as set forth in any of Variations 5-8 wherein the vehicle does not include another infrared transmitting device positioned to transmit infrared waves in the forward path of the vehicle.

Variation 10 may include product as set forth in any of Variations 5-9 wherein the infrared selective filter or lens comprises a substrate having an infrared transmitting coating thereon.

Variation 11 may include product as set forth in any of Variations 5-10 wherein infrared selective filter or lens comprises a substrate comprising at least one of a arsenic trisulfide, barium fluoride, cadmium fluoride, fused silica, gallium arsenide, IR polymers, lead fluoride, lithium fluoride, magnesium fluoride, sapphire (AL₂O₃), sodium chloride, silicon, thallium bromo-iodide, zinc selenide, and/or zinc sulfide so that the infrared selective filter or lens is constructed and arranged to allow infrared waves pass there through and block visible light.

Variation 12 may include product as set forth in any of Variations 5-1 wherein the infrared selective filter or lens is constructed and arranged to block at least 5 percent of an opening in a housing of the headlamp assembly.

Variation 13 may include a method comprising: moving in infrared selective filter or lens in front of light waves projected from a headlamp assembly so that the infrared selective filter or lens blocks visible light and allows transmission of infrared waves in the direction of the movement of light waves projected from the headlamp assembly.

Variation 14 may include method as set forth in Variation 13 wherein the moving an infrared selective filter or lens in front of light wave projected from a headlamp assembly comprises moving a substrate having the infrared transmissible material coated on the substrate or formed in the substrate wherein the infrared transmissible material is constructed and arranged to block visible light and allow the transmission of infrared waves there through.

Variation 15 may include method as set forth in any of Variations 13-14 wherein the substrate comprises an infrared selective filter or lens pivotally connected to a housing of the headlamp assembly.

Variation 16 may include method as set forth in any of Variations 13-14 wherein the moving in the infrared transmissible material comprises providing an actuator connected to the substrate in activating the actuator to move the substrate.

Variation 17 may include a product comprising an infrared device for a vehicle comprising a light transmitting device comprising a lens or shield constructed and arranged to allow the transmission of infrared waves or energy there through, and wherein the lens or shield is moveably by an actuator from a first position allow a certain (first) amount of visible light to pass over or around the lens or shield and to a second position wherein a second amount or visible light is allowed to pass over or around the lens or shield, which is more than or less than the certain (first) amount.

Variation 18 may include a product as set forth in Variation 17 further comprising an actuator operable connected to the lens or shield to move the lens of shield from the first position to the second position.

Variation 19 may include a method comprising: moving in infrared transmissible material in front of light waves projected from a headlamp assembly so that the infrared transmissible material allows infrared waves to pass there through and in the direction of the movement of light waves projected from the headlamp assembly carried out using any of the products of Variations 1-13 and 17-18.

The above description of select examples of the invention is merely illustrative in nature and, thus, variations or variants thereof are not to be regarded as a departure from the spirit and scope of the invention.

What is claimed is:

1. A product comprising an infrared selective filter or lens constructed and arranged to be received in a vehicle headlamp assembly, the infrared selective filter or lens being constructed and arranged to block visible light and to allow the transmission of infrared light waves there through.

2. A product as set forth in claim 1 wherein the infrared selective filter or lens comprises a substrate having an infrared transmitting coating thereon.

3. A product as set forth in claim 1 wherein infrared selective filter or lens comprises a substrate comprising at least one arsenic trisulfide, barium fluoride, cadmium fluoride, fused silica, gallium arsenide, IR polymers, lead fluoride, lithium fluoride, magnesium fluoride, sapphire (AL₂O₃), sodium chloride, silicon, thallium bromo-iodide, zinc selenide, or zinc sulfide constructed and arranged to allow infrared wave to pass through the substrate.

4. A product as set forth in claim 1 wherein the infrared selective filter or lens is a lens constructed and arranged to block at least 5 percent of an opening in a housing of the headlamp assembly.

5. A product as set forth in claim 1 further comprising a headlamp assembly housing having a light projection opening formed therein, a reflective surface formed on an inner surface of the housing communicating with light projection opening, a headlamp bulb received in the headlamp housing and positioned to direct light onto the reflective surface, wherein the infrared selective filter or lens is operatively connected to an actuator to move the infrared selective filter or lens from an open position to a closed position.

6. A product as set forth in claim 5 wherein the infrared selective filter or lens is pivotally connected to the housing.

7. A product as set forth in claim 5 wherein the actuator comprises a solenoid, a hydraulic, pneumatic or electric piston, or a stepper motor.

8. A product as set forth in claim 5 further comprising a vehicle and wherein the headlamp assembly including the infrared selective filter or lens is positioned in the vehicle so that infrared waves projected from the infrared selective filter or lens produces an infrared field of vision in front of the forward path of the vehicle.

9. A product as set forth in claim 8 wherein the vehicle does not include another infrared transmitting device positioned to transmit infrared waves in the forward path of the vehicle.

10. A product as set forth in claim 5 wherein the infrared selective filter or lens comprises a substrate having a coating thereon to allow the transmission of infrared waves there through.

11. A product as set forth in claim 5 wherein infrared selective filter or lens comprises a substrate comprises at least one of arsenic trisulfide, barium fluoride, cadmium fluoride, fused silica, gallium arsenide, IR polymers, lead fluoride, lithium fluoride, magnesium fluoride, sapphire (AL₂O₃), sodium chloride, silicon, thallium bromo-iodide, zinc selenide, or zinc sulfide so that the shield is constructed arranged to allow the transmission of infrared waves there through.

12. A product as set forth in claim 5 wherein the infrared selective filter or lens is a lens constructed and arranged to block at least 5 percent of an opening in a housing of the headlamp assembly.

13. A method comprising:
moving an infrared selective filter or lens in front of light waves projected from a headlamp assembly so that the infrared selective filter or lens blocks visible light and allows transmission of infrared waves in the direction of the movement of light waves projected from the headlamp assembly.

14. A method as set forth in claim 13 wherein the moving an infrared selective filter or lens in front of waves projected from a headlamp assembly comprises moving a substrate comprising an infrared transmissible material or having a coating on the substrate constructed and arranged to block visible light and allow the transmission of infrared waves there through.

15. A method as set forth in claim 14 wherein the substrate comprises a shield pivotally connected to a housing of the headlamp assembly.

16. A method as set forth in claim 15 wherein the moving an infrared selective filter or lens comprises providing an actuator connected to the substrate and activating the actuator to move the substrate.

17. A product comprising an infrared device for a vehicle comprising a light transmitting device comprising a lens or shield constructed and arranged to allow the transmission of infrared waves or energy there through, and wherein the lens or shield is moveably by an actuator from a first position allow a certain (first) amount of visible light to pass over or around the lens or shield and to a second position wherein a second amount or visible light is allowed to pass over or around the lens or shield, which is more than or less than the certain (first) amount.

18. A product as set forth in claim 17 further comprising an actuator operable connected to the lens or shield to move the lens of shield from the first position to the second position.
